(19) United States
(12) Patent Application Publication
(10) Pub. No.: US 2018/0211269 A1
(43) Pub. Date: Jul. 26, 2018

(54) SYSTEMS AND METHODS FOR DETERMINING BEST SELLERS FOR AN ONLINE RETAILER USING DYNAMIC DECAY FACTORS

(71) Applicant: WAL-MART STORES, INC., Bentonville, AR (US)

(72) Inventors: Wei Han, Redwood City, CA (US); Shanth Harikrishnan, San Jose, CA (US)

(73) Assignee: WAL-MART STORES, INC., Bentonville, AR (US)

(21) Appl. No.: 15/412,957

(22) Filed: Jan. 23, 2017

(51) Int. Cl. G06Q 30/02

(52) U.S. Cl. CPC G06Q 30/0204

(57) ABSTRACT

Systems and methods including one or more processing modules and one or more non-transitory storage modules storing computing instructions configured to run on the one or more processing modules and perform acts of receiving sales data for a first plurality of products in a first category and also for a second plurality of products in a second category, determining a first product of the first plurality of products is a best seller in the first category using a first decay factor, determining a second product of the second plurality of products is a best seller in the second category using a second decay factor, coordinating a first display of the first product labeled as the best seller in the first category, and coordinating a second display of the second product labeled as the best seller in the second category.

### TECHNICAL FIELD

This disclosure relates generally to determining best sellers for an online retailer.

### BACKGROUND

Online retailers sometimes label products as “best sellers” on the website of the online retailer. Conventional systems and methods utilized by online retailers typically use the same factors and considerations to determine best sellers, even for different categories of products that change differently over time relative to one another.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIGS. 3 and 5;

FIG. 2 illustrates a representative block diagram of an example of the elements included in the circuit boards inside a chassis of the computer system of FIG. 1;

FIG. 3 illustrates a representative block diagram of a system, according to an embodiment;

FIG. 4 is a flowchart for a method, according to certain embodiments;

FIG. 5 illustrates a representative block diagram of a portion of the system of FIG. 3, according to an embodiment; and

FIG. 6 is an example of a graph showing a plot of decay factors for various categories of products, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can include one or more processing modules and one or more non-transitory storage modules storing computing instructions configured to run on the one or more processing modules. The one or more storage modules can be configured to run on the one or more processing modules and perform the act of receiving first sales data for a first plurality of products in a first category of products offered for sale on a website of an online retailer. The one or more storage modules can be further configured to run on the one or more processing modules and perform the act of determining a first product of the first plurality of products is a best seller in the first category of products using a first decay factor in a first set of rules. The first decay factor can be based on the first sales data and a first frequency of order change of the first plurality of products when ordered by best-selling products in the first category of products. The one or more storage modules can be further configured to run on the one or more processing modules and perform the act of coordinating a first display on the website of the online retailer of the first product labeled as the best seller in the first category of products. The one or more storage modules can be further configured to run on the one or more processing modules and perform the act of receiving second sales data for a second plurality of products in a second category of products offered for sale on the website of the online retailer. The one or more storage modules can be further configured to run on the one or more processing modules and perform the act of determining a second product of the second plurality of products is a best seller in the second category of products using a second decay factor in the first set of rules. The second decay factor can be based on the second sales data and a second frequency of order change of the second plurality of products when ordered by best-selling products in the second category of products. The one or more storage modules can be further configured to run on the one or more processing modules and perform the act of coordinating a second display on the website of the online retailer of the second product labeled as the best seller in the second category of products.

Various embodiments include a method. The method can include receiving first sales data for a first plurality of products in a first category of products offered for sale on a website of an online retailer. The method also can include determining a first product of the first plurality of products is a best seller in the first category of products using a first decay factor in a first set of rules. The first decay factor can be based on the first sales data and a first frequency of order change of the first plurality of products when ordered by best-selling products in the first category of products. The method also can include coordinating a first display on the website of the online retailer of the first product labeled as the best seller in the first category of products. The method also can include receiving second sales data for a second plurality of products in a second category of products offered for sale on the website of the online retailer. The method also can include determining a second product of the second plurality of products is a best seller in the second category of products using a second decay factor in the first set of rules. The second decay factor can be based on the second sales data and a second frequency of order change of the second plurality of products when ordered by best-selling products in the second category of products. The method also can include coordinating a second display on the website of the online retailer of the second product labeled as the best seller in the second category of products.

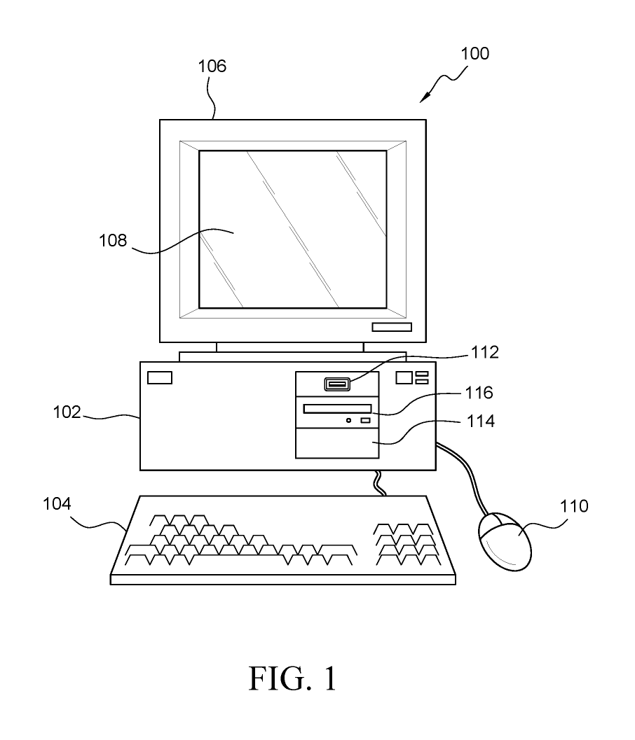

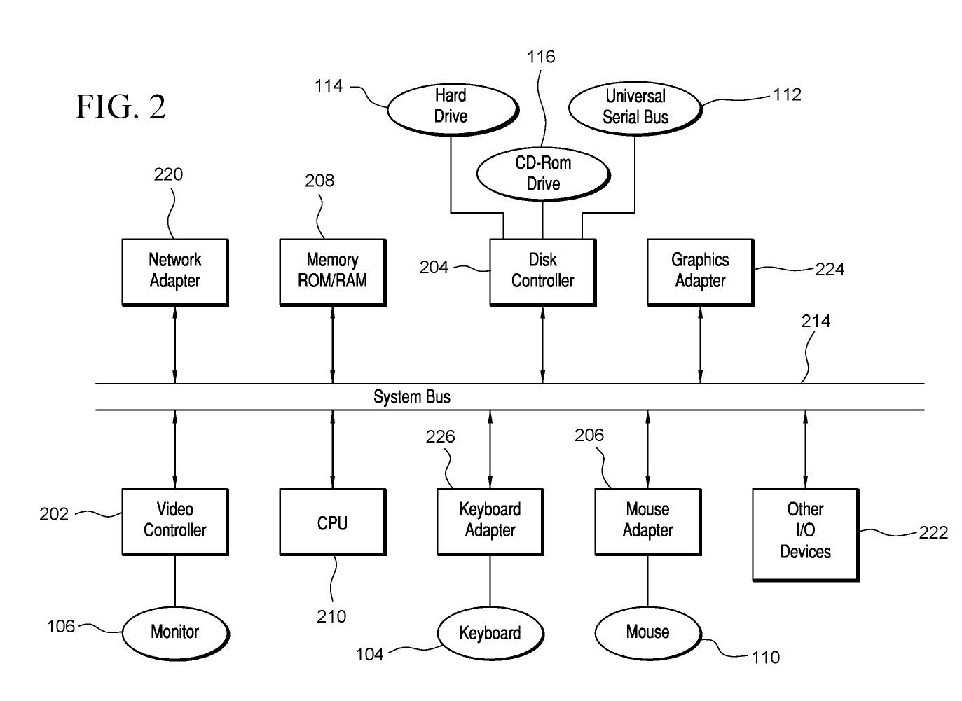

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) volatile (e.g., transitory) memory, such as, for example, read only memory (ROM) and/or (ii) non-volatile (e.g., non-transitory) memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. The memory storage module(s) of the various embodiments disclosed herein can comprise memory storage unit 208, an external memory storage drive (not shown), such as, for example, a USB-equipped electronic memory storage drive coupled to universal serial bus (USB) port 112 (FIGS. 1-2), hard drive 114 (FIGS. 1-2), a CD-ROM and/or DVD for use with CD-ROM and/or DVD drive 116 (FIGS. 1-2), a floppy disk for use with a floppy disk drive (not shown), an optical disc (not shown), a magneto-optical disc (now shown), magnetic tape (not shown), etc. Further, non-volatile or non-transitory memory storage module(s) refer to the portions of the memory storage module(s) that are non-volatile (e.g., non-transitory) memory.

In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

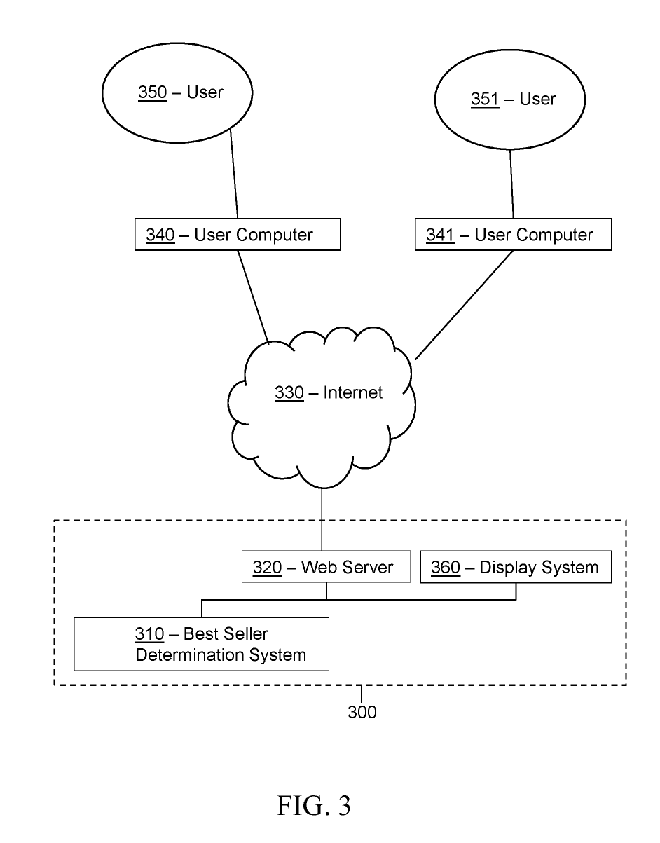

Turning ahead in the drawings, FIG. 3 illustrates a block diagram of a system 300 that can be employed for determining best sellers for an online retailer are described in greater detail below. System 300 is merely exemplary and embodiments of the system are not limited to the embodiments presented herein. System 300 can be employed in many different embodiments or examples not specifically depicted or described herein. In some embodiments, certain elements or modules of system 300 can perform various procedures, processes, and/or activities. In these or other embodiments, the procedures, processes, and/or activities can be performed by other suitable elements or modules of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include a best seller determination system 310, a web server 320, and/or a display system 360. Best seller determination system 310, web server 320, and/or display system 360 can each be a computer system, such as computer system 100 (FIG. 1), as described above, and can each be a single computer, a single server, or a cluster or collection of computers or servers, or a cloud of computers or servers. In another embodiment, a single computer system can host each of two or more of best seller determination system 310, web server 320, and/or display system 360. Additional details regarding best seller determination system 310, web server 320, and display system 360 are described herein.

In many embodiments, system 300 also can comprise user computers 340, 341. In some embodiments, user computers 340, 341 can be a mobile device. A mobile electronic device can refer to a portable electronic device (e.g., an electronic device easily conveyable by hand by a person of average size) with the capability to present audio and/or visual data (e.g., text, images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For examples, in some embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, N.Y., United States of America. In other specific examples, a head mountable wearable user computer device can comprise the Virtual Retinal Display™ product, or similar product by the University of Washington of Seattle, Wash., United States of America. Meanwhile, in further specific examples, a limb mountable wearable user computer device can comprise the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™ product, Flex™ product, Charge™ product, Surge™ product, or similar product by Fitbit Inc. of San Francisco, Calif., United States of America.

In some embodiments, web server 320 can be in data communication through Internet 330 with user computers (e.g., 340, 341). In certain embodiments, user computers 340-341 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, best seller determination system 310, web server 320, and/or display system 360 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) best seller determination system 310, web server 320, and/or display system 360 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of best seller determination system 310, web server 320, and/or display system 360. In a similar manner, the processing module(s) and the memory storage module(s) can be local and/or remote to each other.

In many embodiments, best seller determination system 310, web server 320, and/or display system 360 can be configured to communicate with one or more user computers 340 and 341. In some embodiments, user computers 340 and 341 also can be referred to as customer computers. In some embodiments, best seller determination system 310, web server 320, and/or display system 360 can communicate or interface (e.g., interact) with one or more customer computers (such as user computers 340 and 341) through a network or internet 330. Internet 330 can be an intranet that is not open to the public. Accordingly, in many embodiments, best seller determination system 310, web server 320, and/or display system 360 (and/or the software used by such systems) can refer to a back end of system 300 operated by an operator and/or administrator of system 300, and user computers 340 and 341 (and/or the software used by such systems) can refer to a front end of system 300 used by one or more users 350 and 351, respectively. In some embodiments, users 350 and 351 also can be referred to as customers, in which case, user computers 340 and 341 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

Meanwhile, in many embodiments, best seller determination system 310, web server 320, and/or display system 360 also can be configured to communicate with one or more databases. The one or more databases can comprise a product database that contains information about products, items, or SKUs (stock keeping units) sold by a retailer. The one or more databases can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of the one or more databases, that particular database can be stored on a single memory storage module of the memory storage module(s), and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s).

The one or more databases can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between best seller determination system 310, web server 320, and/or display system 360, and/or the one or more databases can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3 (also known as Ethernet), IEEE 802.11 (also known as WiFi), etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

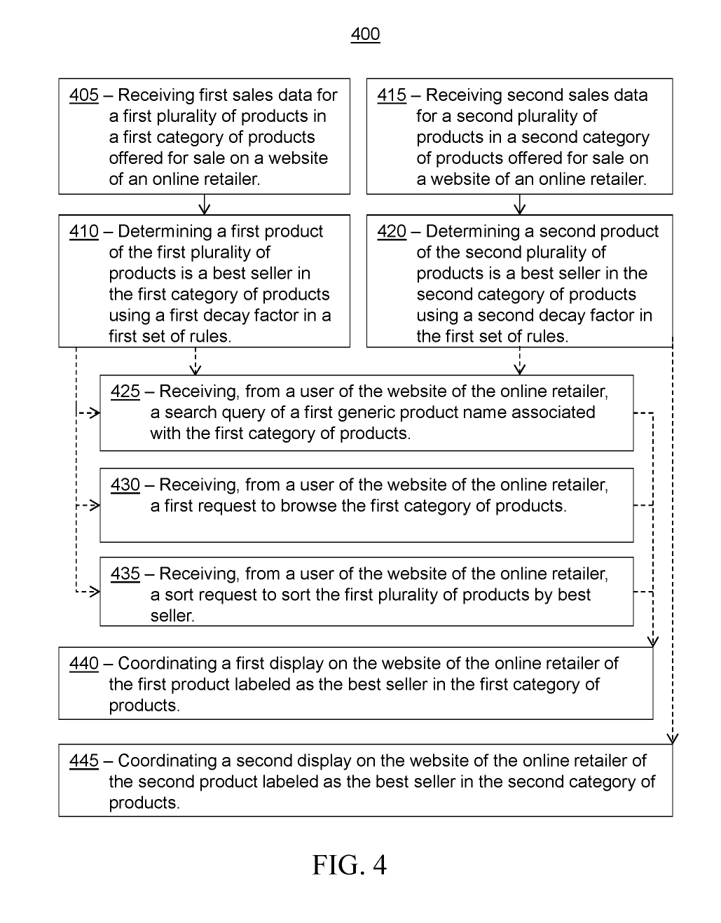

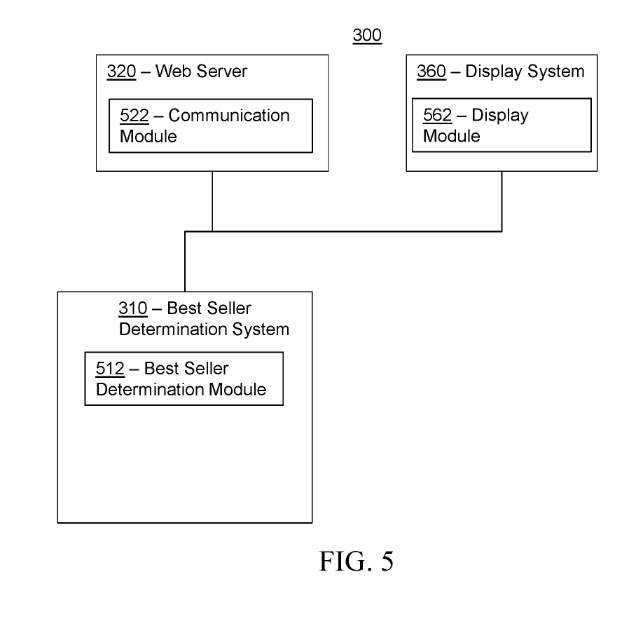

Turning ahead in the drawings, FIG. 4 illustrates a flow chart for a method 400, according to an embodiment. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules 512, 522, and/or 562 (FIG. 5). Such non-transitory memory storage modules can be part of a computer system such as best seller determination system 310, web server 320, and/or display system 360 (FIGS. 3 & 5). The processing module(s) can be similar or identical to the processing module(s) described above with respect to computer system 100 (FIG. 1).

Some embodiments of method 400 can improve computation of best sellers in multiple categories on the website of an online retailer by using one or more factors unique to each category of products of the multiple categories. Purchasing trends for products varies significantly from category to category. For example, purchasing trends for products within categories such as electronics and clothes can change quickly, while purchasing trends for products within other categories such as home products can change slowly. As shall be described in greater detail below, improving computation of the best sellers in multiple categories can capture trending behavior for each category. Application of the best seller label or tag can be useful when a user or customer enters a search query on a web site of the online retailer, sorts products by best sellers on the web site of the online retailer, and/or browses a baseline ranking on the website of the online retailer. In some embodiments, use of a dynamic decay factor to determine best sellers for each category can increase a conversion rate for products available on the website of the online retailer.

In some embodiments, method 400 can comprise an activity of receiving sales data for a plurality of products sold by an online retailer. Although reference is made to an online retailer, the online retailer can comprise an online retailer associated with a brick and mortar retailer or, alternatively, an online retailer that sells products exclusively online and not in a brick and mortar retailer. The sales data can be for a plurality of products in a plurality of categories and subcategories of products offered by an online retailer. When the online retailer is associated with a brick and mortar retailer, the sales data can be for online sales only or online and in-store sales combined. In some embodiments, the sales data can comprise a quantity of a product sold on a specific day and/or during a specific period of predetermined time, such as but not limited to a week, a month, a year, and the like. In more particular embodiments, method 400 can comprise an activity 405 of receiving first sales data for a first plurality of products in a first category of products offered for sale on a website of an online retailer. Similarly, method 400 also can comprise an activity 415 of receiving second sales data for a second plurality of products in a second category of products offered for sale on the website of the online retailer. In some embodiments, the first sales data for the first plurality of products and the second sales data for the second plurality of products can be received as combined sales data for multiple categories of products, and system 300 (FIG. 3) can separate the combined sales data into predetermined categories and/or subcategories.

In some embodiments, a determination of a best seller for each category of products can include dynamic behavior of purchasing trends that are unique to each category of products. Determining the dynamic behavior of purchasing trends in each category of products can help in differentiating between categories with quick changes in purchasing trends and categories with slow changes in purchasing trends. Thus, a decay factor for a particular category can be based on how often the best-selling item for that particular category changes from one product to a different product. Returning to FIG. 4, method 400 also can comprise an activity 410 of determining a first product of the first plurality of products is a best seller in the first category of products using a first decay factor in a first set of rules. The first decay factor is unique to the first category of products. In some embodiments, the first decay factor can be based on the first sales data and a first frequency of order change of the first plurality of products when ordered by best-selling products in the first category of products.

Similarly, method 400 also can comprise an activity 420 of determining a second product of the second plurality of products is a best seller in the second category of products using a second decay factor in the first set of rules. The second decay factor can be based on the second sales data and a second frequency of order change of the second plurality of products when ordered by best-selling products in the second category of products.

As noted above, a set of rules can be used to determine a best seller for each category of multiple categories. In some embodiments, the set of rules used to determine the best seller for each category can comprise

$${BS}_{i} ( σ ) = \frac{{\sum }_{t = 1}^{30} {σ}^{t} {x}_{i , t}}{{\sum }_{t = 1}^{30} {σ}^{t}}$$

where BSᵢ is a best seller score for a product i of a plurality of products in a particular category, σ is a decay factor for the particular category, and x_{i,t} is a quantity of the product i sold on a t^{th} day before a given day. In some embodiments, method 400 also can comprise an activity of optimizing the first set of rules to obtain BSᵢ(σ) at the given day that is closest to a value of x_{i,0}, where x_{i,0} is the quantity of the product i sold on the given day, with an objective function

$$Obj ( σ ) = {\sum }_{i} {( \frac{{\sum }_{t = 1}^{30} {σ}^{t} {x}_{i , t}}{{\sum }_{t = 1}^{30} {σ}^{t}} - {x}_{i , 0} )}^{2} .$$

In some embodiments, method 400 also can comprise finding σ∈(0,1] to minimize Obj(σ) as an optimal decay factor σ.

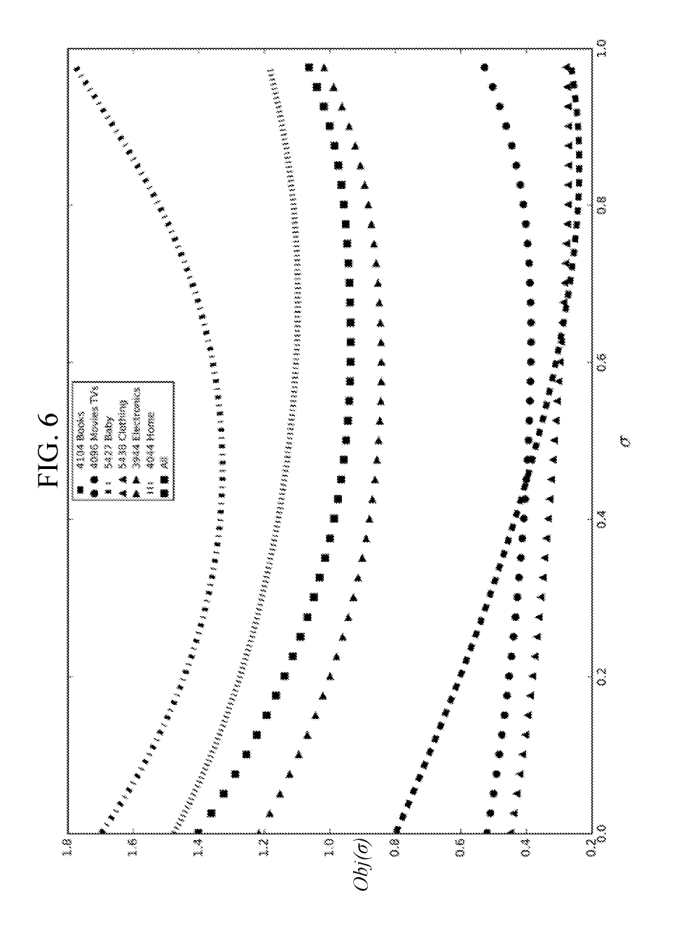

In some embodiments, method 400 also can comprise an activity of determining the optimal decay factor σ for each particular category using a grid search. For example, FIG. 6 is a non-limiting example of a graph showing a plot of Obj(σ) for various categories including books, movies & TVs, baby, clothing, electronics, home, and all categories. In some embodiments, determining the optimal decay factor σ for each particular category can comprise activities of dividing a range of a into 1,000 parts for an x-axis of a graph, obtaining a value of Obj(σ) at each part of the 1,000 parts, the Obj(σ) comprising a y-axis of the graph, plotting Obj(σ) as a curve on the graph having a convex shape relative to the x-axis, and selecting as the optimal decay factor σ a part of the 1,000 parts which archives a smallest Obj(σ) value on the curve. In the non-limiting example shown in FIG. 6, the 1,000 parts are divided between 0.0 and 1.0, e.g., 0.827, 0.807, and 0.768.

Because the decay factor for each category of products is based on one or more factors unique to each category, the decay factor for each category can be a numerical value that is different from a numerical value of a decay factor for other categories. For example, the first decay factor can less than the second decay factor. When the first decay factor is less than the second decay factor, this difference can indicate a more frequent change of the best seller of products of the first plurality of products in the first category of products and a less frequent change of the best seller of products of the second plurality of products in the second category of products. In such an example, the more frequent change can be more frequent than the less frequent change. In the example above, optimal decay factors are between 0 and 1. When the optimal decay factor for a category is closer to 1, the category changes less than a category with an optimal decay factor closer to 0. As a non-limiting example, optimal decay factors were determined for each of the following categories using the activities described above:

| Category | Decay Factor |
|---|---|
| Video Games | 0.113 |
| Books | 0.676 |
| Electronics | 0.768 |
| Home | 0.831 |
| Movies & TV | 0.827 |
| Music | 0.815 |
| Toys | 0.808 |
| Baby | 0.667 |
| Clothing | 0.807 |
| Auto & Tires | 0.861 |
| Cell Phones | 0.877 |
| Household Essentials | 0.966 |

As can be seen, video games have a decay factor relatively close to 0, while household essential items have a decay factor relatively close to 1. This indicates that the best sellers in the video game change relatively frequently, while the best sellers in the household essentials category change relatively infrequently.

In some embodiments, unique decay factors as described above also can be applied to multiple subcategories within a specific category. For example, a first subcategory within a category can have first decay factor that is unique to the first subcategory and different than a second decay factor for a second subcategory within the same category. More particularly, in some embodiments the first plurality products in the first category of products can comprise (1) a first additional plurality of products in a first subcategory of products within the first category of products, and also (2) a second additional plurality of products in a second subcategory of products within the first category of products.

In embodiments of method 400 that include determining best sellers for different subcategories within a subcategory, method 400 also can comprise an activity of determining a first additional product of the first additional plurality of products is a best seller in the first subcategory of products using a first additional decay factor in the first set of rules. The first additional decay factor can be based on the first sales data and a first additional frequency of order change of the first additional plurality of products when ordered by best-selling products in the first subcategory of products. Method 400 also can comprise an activity of determining a second additional product of the second additional plurality of products is a best seller in the second subcategory of products using a second additional decay factor in the first set of rules. The second additional decay factor can be based on the first sales data and a second additional frequency of order change of the second additional plurality of products when ordered by best-selling products in the second subcategory of products.

Once the best sellers for each category and/or subcategory of each category are determined, system 300 (FIG. 3) can coordinate display of the product determined to be the best seller for each category and/or subcategory. When the product is displayed, the display of the product can comprise a label labeling the product as “Best Seller.” In addition to a best seller label, the display of the product determined to be the best seller for the category or subcategory also can comprise one or more of a picture of the product, a title of the product, information about the product, and/or a link to a webpage for the product on the website of the online retailer. For example, returning to FIG. 4, method 400 also can comprise an activity 440 of coordinating a first display on the web site of the online retailer of the first product labeled as the best seller in the first category of products and an activity 445 of coordinating a second display on the website of the online retailer of the second product labeled as the best seller in the second category of products.

In embodiments of method 400 that include determining best sellers for different subcategories within a subcategory, method 400 also can comprise activities of coordinating a display of products determined to be and labeled as best sellers for particular subcategories. For example, method 400 can comprise an activity of coordinating a first additional display on the website of the online retailer of the first additional product labeled as the best seller in the first subcategory of products, and/or coordinating a second additional display on the website of the online retailer of the second additional product labeled as the best seller in the second subcategory of products.

The use of dynamic decay factors unique to each category and/or subcategory to determine best sellers for each category and/or subcategory can be useful for customers or users of the website of the online retailer. For example, in some embodiments, a user can enter search query for a generic product name into the search window of the website of the online retailer. The generic product name can include a generic name of products, such as “kayaks,” “shoes,” “televisions,” and the like. The generic product name also can include more specific names of products to direct a search to a subcategory within a general category, such as “basketball shoes” or “LED televisions.” Upon receiving the search query, system 300 (FIG. 3) can determine the category and/or subcategory relevant to the search query, and then coordinate a display on an electronic device of the user of the best seller for the category and/or subcategory according to the first set of rules and the decay factor for that category or subcategory, as well as additional products relevant to the search query. In some embodiments, a set of best sellers for the same category can be coordinated for display to the user. For example, a set of best sellers for the same category can include the top two, three, or four sellers for a category. In some embodiments, system 300 only had the best seller label to one or more products, and does not change the order and/or returned products in search results.

Returning to FIG. 4, then, method 400 can optionally comprise an activity 425 of receiving, from a user of the web site of the online retailer, a search query of a first generic product name associated with the first category of products. If system 300 (FIG. 3) receives the search query for a first generic product, the activity of coordinating the first display can comprise an activity coordinating the first display on a first webpage of the website of the online retailer. The first display can comprise the first product labeled as the best seller in the first category or plurality of products, and also one or more first additional products of the first plurality of products. While reference is made here to the first product labeled as the best seller in the first category or plurality of products, and the first webpage, it is also contemplated that the same or similar activities may be performed for the second product labeled as the best seller in the second category or plurality of products, and the second webpage, as well as any other product determined to be and labeled as the best seller for any other category or subcategory. In some embodiments, activity 425 can occur before or after activities 415, 420, and 445.

The use of dynamic decay factors unique to each category and/or subcategory to determine best sellers for each category and/or subcategory also can be useful for customers or users of the web site of the online retailer who wish to browse categories of products on the website of the online retailer. For example, a user may wish to browse the category of “televisions” or a subcategory of “LED televisions.” Upon selection by the user of the category or subcategory, system 300 (FIG. 3) can coordinate display of products in the category or subcategory, with the product determined to be the best seller according to the first set of rules and the decay factor for that category or subcategory labeled as the best seller.

Returning to FIG. 4, then, in some embodiments, method 400 can optionally comprise an activity 430 of receiving, from a user of the website of the online retailer, a first request to browse the first category of products. If system 300 (FIG. 3) receives a request to browse the first category of products, coordinating the first display can comprise an activity of coordinating the first display on a first webpage of the website of the online retailer. The first display can comprise the first product labeled as the best seller and also one or more first additional products of the first plurality of products. While reference is made here to the first product labeled as the best seller in the first category or plurality of products, and the first webpage, it is also contemplated that the same or similar activities may be performed for the second product labeled as the best seller in the second category or plurality of products, and the second webpage, as well as any other product determined to be and labeled as the best seller for any other category or subcategory. In some embodiments, activity 430 can occur before or after activities 415, 420, and 445.

The use of dynamic decay factors unique to each category and/or subcategory to determine best sellers for each category and/or subcategory also can be useful for customers or users of the website of the online retailer who wish to sort products in order of best seller within a category or subcategory. For example, a user may wish to sort televisions on the website of the online retailer in order of best-selling televisions. Responsive to a request to sort by best seller, system 300 (FIG. 3) can coordinate display of the best sellers of a category or subcategory in order of best sellers according to the first set of rules and the decay factor for that category or subcategory. In some embodiments, a user can sort products by a combination of best seller and also relevance. For example, products can be ranked based on a best seller score as determined according to any of the embodiments described herein, and also based on one or more other relevance attribute scores. In other embodiments, a user can sort products only by a best seller score. For example, the sorting of products is based entirely upon a best seller score.

Returning to FIG. 4, then, in some embodiments method 400 can optionally comprise an activity 435 of receiving, from a user of the web site of the online retailer, a sort request to sort the first plurality of products by best seller. If system 300 (FIG. 3) receives a sort request, coordinating the first display can comprise an activity of coordinating the first display on a first webpage of the website of the online retailer. The first display can comprise the first product labeled as the best seller in the first category of products and also one or more first additional products of the first plurality of products in order of best-selling products as determined by using the first decay factor and the first set of rules. While reference is made here to the first product labeled as the best seller in the first category or plurality of products, and the first webpage, it is also contemplated that the same or similar activities may be performed for the second product labeled as the best seller in the second category or plurality of products, and the second webpage, as well as any other product determined to be and labeled as the best seller for any other category or subcategory. In some embodiments, activity 435 can occur before or after activities 415, 420, and 445.

Method 400 can further comprise an activity of retrieving information about the plurality of products and/or the plurality of categories of products from a database associated with the online retailer. In some embodiments, retrieving information can comprise using a distributed network comprising distributed memory architecture to retrieve information about the plurality of products and/or the plurality of categories of products. This distributed architecture can reduce the impact on the network and system resources to reduce congestion in bottlenecks while still allowing data to be accessible from a central location. In some embodiments retrieving information is performed while a user is shopping on a website of the online retailer, e.g., when a user enters a search query, browses categories of products, and/or sorts products in order of best sellers. In some embodiments, retrieving information is performed when system 300 (FIG. 3) receives sales data and/or determines best sellers for each category and/or subcategory of products.

FIG. 5 illustrates a block diagram of a portion of system 300 comprising best seller determination system 310, web server 320, and display system 360, according to the embodiment shown in FIG. 3. Each of best seller determination system 310, web server 320, and/or display system 360, is merely exemplary and not limited to the embodiments presented herein. Each of best seller determination system 310, web server 320, and/or display system 360, can be employed in many different embodiments or examples not specifically depicted or described herein. In some embodiments, certain elements or modules of best seller determination system 310, web server 320, and/or display system 360, can perform various procedures, processes, and/or acts. In other embodiments, the procedures, processes, and/or acts can be performed by other suitable elements or modules.

In many embodiments, best seller determination system 310 can comprise non-transitory storage module 512. Memory storage module 512 can be referred to as best seller determination module 512. In many embodiments, best seller determination module 512 can store computing instructions configured to run on one or more processing modules and perform one or more acts of method 400 (FIG. 4) (e.g., activity 405 of receiving first sales data for a first plurality of products in a first category of products offered for sale on a website of an online retailer (FIG. 4), activity 410 of determining a first product of the first plurality of products is a best seller in the first category of products using a first decay factor in a first set of rules (FIG. 4), activity 415 of receiving second sales data for a second plurality of products in a second category of products offered for sale (FIG. 4), activity 420 of determining a second product of the second plurality of products is a best seller in the second category of products using a second decay factor in the first set of rules (FIG. 4), an activity of determining a first additional product of the first additional plurality of products is a best seller in the first subcategory of products using a first additional decay factor in the first set of rules, the first additional decay factor being based on the first sales data and a first additional frequency of order change of the first additional plurality of products when ordered by best-selling products in the first subcategory of products, an activity of determining a second additional product of the second additional plurality of products is a best seller in the second subcategory of products using a second additional decay factor in the first set of rules, the second additional decay factor being based on the first sales data and a second additional frequency of order change of the second additional plurality of products when ordered by best-selling products in the second subcategory of products, an activity of optimizing the first set of rules to obtain BSᵢ(σ) at the given day that is closest to a value of x_{i,0}, and an activity of finding σ∈(0,1] to minimize Obj(σ) as an optimal decay factor σ, and an activity of determining the optimal decay factor σ).

In many embodiments, web server 320 can comprise non-transitory storage module 522. Memory storage module 522 can be referred to as communication module 522. In many embodiments, communication module 522 can store computing instructions configured to run on one or more processing modules and perform one or more acts of method 400 (FIG. 4) (e.g., activity 425 of receiving, from a user of the web site of the online retailer, a search query of a first generic product name associated with the first category of products, activity 430 of receiving, from a user of the website of the online retailer, a first request to browse the first category of products, and activity 435 of receiving, from a user of the website of the online retailer, a sort request to sort the first plurality of products by best seller (FIG. 4)).

In many embodiments, display system 360 can comprise non-transitory storage module 562. Memory storage module 562 can be referred to as display module 562. In many embodiments, display module 562 can store computing instructions configured to run on one or more processing modules and perform one or more acts of method 400 (FIG. 4) (e.g., activity 440 of coordinating a first display on the website of the online retailer of the first product labeled as the best seller in the first category of products (FIG. 4), and activity 445 of coordinating a second display on the website of the online retailer of the second product labeled as the best seller in the second category of products (FIG. 4)).

Although systems and methods for determining best sellers for an online retailer, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processing modules; and
one or more non-transitory storage modules storing computing instructions configured to run on the one or more processing modules and perform acts of:
receiving first sales data for a first plurality of products in a first category of products offered for sale on a website of an online retailer;
determining a first product of the first plurality of products is a best seller in the first category of products using a first decay factor in a first set of rules, the first decay factor being based on the first sales data and a first frequency of order change of the first plurality of products when ordered by best-selling products in the first category of products;
coordinating a first display on the website of the online retailer of the first product labeled as the best seller in the first category of products;
receiving second sales data for a second plurality of products in a second category of products offered for sale on the website of the online retailer;
determining a second product of the second plurality of products is a best seller in the second category of products using a second decay factor in the first set of rules, the second decay factor being based on the second sales data and a second frequency of order change of the second plurality of products when ordered by best-selling products in the second category of products; and
coordinating a second display on the website of the online retailer of the second product labeled as the best seller in the second category of products.

2. The system of claim 1, wherein:
the first decay factor is less than the second decay factor, indicating a more frequent change of the best seller of products of the first plurality of products in the first category of products and a less frequent change of the best seller of products of the second plurality of products in the second category of products; and
the more frequent change is more frequent than the less frequent change.

3. The system of claim 1, wherein:
the one or more non-transitory storage modules storing the computing instructions are further configured to run on the one or more processing modules and perform an act of receiving, from a user of the website of the online retailer, a search query of a first generic product name associated with the first category of products; and
coordinating the first display comprises coordinating the first display on a first webpage of the website of the online retailer, the first display comprising the first product labeled as the best seller in the first category of products and also one or more first additional products of the first plurality of products.

4. The system of claim 1, wherein:
the one or more non-transitory storage modules storing the computing instructions are further configured to run on the one or more processing modules and perform an act of receiving, from a user of the website of the online retailer, a first request to browse the first category of products; and
coordinating the first display comprises coordinating the first display on a first webpage of the website of the online retailer, the first display comprising the first product labeled as the best seller in the first category of products and also one or more first additional products of the first plurality of products.

5. The system of claim 1, wherein:
the one or more non-transitory storage modules storing the computing instructions are further configured to run on the one or more processing modules and perform an act of receiving, from a user of the website of the online retailer, a sort request to sort the first plurality of products by best seller; and
coordinating the first display comprises coordinating the first display on a first webpage of the website of the online retailer, the first display comprising the first product labeled as the best seller in the first category of products and also one or more first additional products of the first plurality of products in order of best-selling products as determined by using the first decay factor and the first set of rules.

6. The system of claim 1, wherein:
the first plurality products in the first category of products comprises (1) a first additional plurality of products in a first subcategory of products within the first category of products, and also (2) a second additional plurality of products in a second subcategory of products within the first category of products; and
the one or more non-transitory storage modules storing the computing instructions are further configured to run on the one or more processing modules and perform acts of:
determining a first additional product of the first additional plurality of products is a best seller in the first subcategory of products using a first additional decay factor in the first set of rules, the first additional decay factor being based on the first sales data and a first additional frequency of order change of the first additional plurality of products when ordered by best-selling products in the first subcategory of products;
determining a second additional product of the second additional plurality of products is a best seller in the second subcategory of products using a second additional decay factor in the first set of rules, the second additional decay factor being based on the first sales data and a second additional frequency of order change of the second additional plurality of products when ordered by best-selling products in the second subcategory of products;
coordinating a first additional display on the website of the online retailer of the first additional product labeled as the best seller in the first subcategory of products; and
coordinating a second additional display on the website of the online retailer of the second additional product labeled as best seller in the second subcategory of products.

7. The system of claim 1, wherein the first set of rules comprises:
$${BS}_{i} ( σ ) = \frac{{\sum }_{t = 1}^{30} {σ}^{t} {x}_{i , t}}{{\sum }_{t = 1}^{30} {σ}^{t}}$$
where BSᵢ is a best seller score for a product i of the first plurality of products or the second plurality of products, σ is the first decay factor or the second decay factor, and x_{i,t} is a quantity of the product i sold on a t^{th} day before a given day.

8. The system of claim 7, wherein the one or more non-transitory storage modules storing the computing instructions are further configured to run on the one or more processing modules and perform acts of:
optimizing the first set of rules to obtain BSᵢ(σ) at the given day that is closest to a value of x_{i,0}, where x_{i,0} is the quantity of the product i sold on the given day, with an objective function
$$Obj ( σ ) = {\sum }_{i} {( \frac{{\sum }_{t = 1}^{30} {σ}^{t} {x}_{i , t}}{{\sum }_{t = 1}^{30} {σ}^{t}} - {x}_{i , 0} )}^{2} ;$$
and
finding σ∈(0,1] to minimize Obj(σ) as an optimal decay factor σ.

9. The system of claim 8, wherein the one or more non-transitory storage modules storing the computing instructions are further configured to run on the one or more processing modules and perform acts of:
determining the optimal decay factor σ by:
dividing a range of σ into 1,000 parts for an x-axis of a graph;
obtaining a value of Obj(σ) at each part of the 1000 parts, the Obj(σ) comprising a y-axis of the graph;
plotting Obj(σ) as a curve on the graph having a convex shape relative to the x-axis; and
selecting as the optimal decay factor σ a part of the 1,000 parts which archives a smallest Obj(σ) value on the curve.

10. The system of claim 1, wherein:
the first decay factor is less than the second decay factor, indicating a more frequent change of the best seller of products of the first plurality of products in the first category of products and a less frequent change of the best seller of products of the second plurality of products in the second category of products; and
the more frequent change is more frequent than the less frequent change.
the one or more non-transitory storage modules storing the computing instructions are further configured to run on the one or more processing modules and perform acts of:
receiving, from a user of the website of the online retailer, a search query of a first generic product name associated with the first category of products, wherein if the one or more processing modules receive the search query, coordinating the first display comprises coordinating the first display on a first webpage of the website of the online retailer, the first display comprising the first product labeled as the best seller in the first category of products and also one or more first additional products of the first plurality of products;
receiving, from the user of the website of the online retailer, a first request to browse the first category of products, wherein if the one or more processing modules receive the first request, coordinating the first display comprises coordinating the first display on a second webpage of the website of the online retailer, the first display comprising the first product labeled as the best seller in the first category of products and also the one or more first additional products of the first plurality of products; and
receiving, from the user of the website of the online retailer, a sort request to sort the first plurality of products by best seller, wherein if the one or more processing modules receive the sort request, coordinating the first display comprises coordinating the first display on a third webpage of the website of the online retailer, the first display comprising the first product labeled as the best seller in the first category of products and also the one or more first additional products of the first plurality of products in order of best-selling products as determined by using the first decay factor and the first set of rules;
the first plurality products in the first category of products comprises (1) a first additional plurality of products in a first subcategory of products within the first category of products, and also (2) a second additional plurality of products in a second subcategory of products within the first category of products;
the one or more non-transitory storage modules storing the computing instructions are further configured to run on the one or more processing modules and perform acts of:
determining a first additional product of the first additional plurality of products is a best seller in the first subcategory of products using a first additional decay factor in the first set of rules, the first additional decay factor being based on the first sales data and a first additional frequency of order change of the first additional plurality of products when ordered by best-selling products in the first subcategory of products;
determining a second additional product of the second additional plurality of products is a best seller in the second subcategory of products using a second additional decay factor in the first set of rules, the second additional decay factor being based on the first sales data and a second additional frequency of order change of the second additional plurality of products when ordered by best-selling products in the second subcategory of products;
coordinating a first additional display of the first additional product on the website of the online retailer labeled as the best seller in the first subcategory of products; and
coordinating a second additional display of the second additional product on the website of the online retailer labeled as the best seller in the second subcategory of products;
the first set of rules comprises:
$${BS}_{i} ( σ ) = \frac{{\sum }_{t = 1}^{30} {σ}^{t} {x}_{i , t}}{{\sum }_{t = 1}^{30} {σ}^{t}}$$
where BSᵢ is a best seller score for a product i of the first plurality of products or the second plurality of products, σ is the first decay factor or the second decay factor, and x_{i,t} is a quantity of the product i sold on a t^{th} day before a given day; and
the one or more non-transitory storage modules storing the computing instructions are further configured to run on the one or more processing modules and perform acts of:
optimizing the first set of rules to obtain BSᵢ(σ) at the given day that is closest to a value of x_{i,0}, where x_{i,0} is the quantity of the product i sold on the given day, with an objective function
$$Obj ( σ ) = {\sum }_{i} {( \frac{{\sum }_{t = 1}^{30} {σ}^{t} {x}_{i , t}}{{\sum }_{t = 1}^{30} {σ}^{t}} - {x}_{i , 0} )}^{2} ;$$
finding σ∈(0,1] to minimize Obj(σ) as an optimal decay factor σ; and
determining the optimal decay factor σ by:
dividing a range of σ into 1,000 parts for an x-axis of a graph;
obtaining a value of Obj(σ) at each part of the 1,000 parts, the Obj(σ) comprising a y-axis of the graph;
plotting Obj(σ) as a curve on the graph having a convex shape relative to the x-axis; and
selecting as the optimal decay factor σ a part of the 1,000 parts which archives a smallest Obj(σ) value on the curve.

11. A method comprising:
receiving first sales data for a first plurality of products in a first category of products offered for sale on a website of an online retailer;
determining a first product of the first plurality of products is a best seller in the first category of products using a first decay factor in a first set of rules, the first decay factor being based on the first sales data and a first frequency of order change of the first plurality of products when ordered by best-selling products in the first category of products;
coordinating a first display on the website of the online retailer of the first product labeled as the best seller in the first category of products;
receiving second sales data for a second plurality of products in a second category of products offered for sale on the website of the online retailer;
determining a second product of the second plurality of products is a best seller in the second category of products using a second decay factor in the first set of rules, the second decay factor being based on the second sales data and a second frequency of order change of the second plurality of products when ordered by best-selling products in the second category of products; and
coordinating a second display on the website of the online retailer of the second product labeled as the best seller in the second category of products.

12. The method of claim 11, wherein:
the first decay factor is less than the second decay factor, indicating a more frequent change of the best seller of products of the first plurality of products in the first category of products and a less frequent change of the best seller of products of the second plurality of products in the second category of products; and
the more frequent change is more frequent than the less frequent change.

13. The method of claim 11, wherein:
the method further comprises receiving, from a user of the website of the online retailer, a search query of a first generic product name associated with the first category of products; and
coordinating the first display comprises coordinating the first display on a first webpage of the website of the online retailer, the first display comprising the first product labeled as the best seller in the first category of products and also one or more first additional products of the first plurality of products.

14. The method of claim 11, wherein:
the method further comprises receiving, from a user of the website of the online retailer, a first request to browse the first category of products; and
coordinating the first display comprises coordinating the first display on a first webpage of the website of the online retailer, the first display comprising the first product labeled as the best seller in the first category of products and also one or more first additional products of the first plurality of products.

15. The method of claim 11, wherein:
the method further comprises receiving, from a user of the website of the online retailer, a sort request to sort the first plurality of products by best seller; and
coordinating the first display comprises coordinating the first display on a first webpage of the website of the online retailer, the first display comprising the first product labeled as the best seller in the first category of products and also one or more first additional products of the first plurality of products in order of best-selling products as determined by using the first decay factor and the first set of rules.

16. The method of claim 11, wherein:
the first plurality products in the first category of products comprises (1) a first additional plurality of products in a first subcategory of products within the first category of products, and also (2) a second additional plurality of products in a second subcategory of products within the first category of products; and
the method further comprises:
determining a first additional product of the first additional plurality of products is a best seller in the first subcategory of products using a first additional decay factor in the first set of rules, the first additional decay factor being based on the first sales data and a first additional frequency of order change of the first additional plurality of products when ordered by best-selling products in the first subcategory of products;
determining a second additional product of the second additional plurality of products is a best seller in the second subcategory of products using a second additional decay factor in the first set of rules, the second additional decay factor being based on the first sales data and a second additional frequency of order change of the second additional plurality of products when ordered by best-selling products in the second subcategory of products;
coordinating a first additional display on the website of the online retailer of the first additional product labeled as the best seller in the first subcategory of products; and
coordinating a second additional display on the website of the online retailer of the second additional product labeled as the best seller in the second subcategory of products.

17. The method of claim 11, wherein the first set of rules comprises:
$${BS}_{i} ( σ ) = \frac{{\sum }_{t = 1}^{30} {σ}^{t} {x}_{i , t}}{{\sum }_{t = 1}^{30} {σ}^{t}}$$
where BSᵢ is a best seller score for a product i of the first plurality of products or the second plurality of products, σ is the first decay factor or the second decay factor, and x_{i,t} is a quantity of the product i sold on a t^{th} day before a given day.

18. The method of claim 17, wherein the method further comprises:
optimizing the first set of rules to obtain BSᵢ(σ) at the given day that is closest to a value of x_{i,0}, where x_{i,0} is the quantity of the product i sold on the given day, with an objective function
$$Obj ( σ ) = {\sum }_{i} {( \frac{{\sum }_{t = 1}^{30} {σ}^{t} {x}_{i , t}}{{\sum }_{t = 1}^{30} {σ}^{t}} - {x}_{i , 0} )}^{2} ;$$
and
finding σ∈(0,1] to minimize Obj(σ) as an optimal decay factor σ.

19. The method of claim 18, wherein the method further comprises:
determining the optimal decay factor σ by:
dividing a range of σ into 1,000 parts for an x-axis of a graph;
obtaining a value of Obj(σ) at each part of the 1000 parts, the Obj(σ) comprising a y-axis of the graph;
plotting Obj(σ) as a curve on the graph having a convex shape relative to the x-axis; and
selecting as the optimal decay factor σ a part of the 1,000 parts which archives a smallest Obj(σ) value on the curve.

20. The method of claim 11, wherein:
the first decay factor is less than the second decay factor, indicating a more frequent change of the best seller of products of the first plurality of products in the first category of products and a less frequent change of the best seller of products of the second plurality of products in the second category of products; and
the more frequent change is more frequent than the less frequent change.
the method further comprises:
receiving, from a user of the website of the online retailer, a search query of a first generic product name associated with the first category of products, wherein if the one or more processing modules receive the search query, coordinating the first display comprises coordinating the first display on a first webpage of the website of the online retailer, the first display comprising the first product labeled as the best seller in the first category of products and also one or more first additional products of the first plurality of products;
receiving, from the user of the website of the online retailer, a first request to browse the first category of products, wherein if the one or more processing modules receive the first request, coordinating the first display comprises coordinating the first display on a second webpage of the website of the online retailer, the first display comprising the first product labeled as the best seller in the first category of products and also the one or more first additional products of the first plurality of products; and
receiving, from the user of the website of the online retailer, a sort request to sort the first plurality of products by best seller, wherein if the one or more processing modules receive the sort request, coordinating the first display comprises coordinating the first display on a third webpage of the website of the online retailer, the first display comprising the first product labeled as the best seller in the first category of products and also the one or more first additional products of the first plurality of products in order of best-selling products as determined by using the first decay factor and the first set of rules;
the first plurality products in the first category of products comprises (1) a first additional plurality of products in a first subcategory of products within the first category of products, and also (2) a second additional plurality of products in a second subcategory of products within the first category of products;
the method further comprises:
determining a first additional product of the first additional plurality of products is a best seller in the first subcategory of products using a first additional decay factor in the first set of rules, the first additional decay factor being based on the first sales data and a first additional frequency of order change of the first additional plurality of products when ordered by best-selling products in the first subcategory of products;
determining a second additional product of the second additional plurality of products is a best seller in the second subcategory of products using a second additional decay factor in the first set of rules, the second additional decay factor being based on the first sales data and a second additional frequency of order change of the second additional plurality of products when ordered by best-selling products in the second subcategory of products;
coordinating a first additional display of the first additional product on the website of the online retailer labeled as the best seller in the first subcategory of products; and
coordinating a second additional display of the second additional product on the website of the online retailer labeled as the best seller in the second subcategory of products;
the first set of rules comprises:
$${BS}_{i} ( σ ) = \frac{{\sum }_{t = 1}^{30} {σ}^{t} {x}_{i , t}}{{\sum }_{t = 1}^{30} {σ}^{t}}$$
where BSᵢ is a best seller score for a product i of the first plurality of products or the second plurality of products, σ is the first decay factor or the second decay factor, and x_{i,t} is a quantity of the product i sold on a t^{th} day before a given day; and
the method further comprises:
optimizing the first set of rules to obtain BSᵢ(σ) at the given day that is closest to a value of x_{i,0}, where x_{i,0} is the quantity of the product i sold on the given day, with an objective function
$$Obj ( σ ) = {\sum }_{i} {( \frac{{\sum }_{t = 1}^{30} {σ}^{t} {x}_{i , t}}{{\sum }_{t = 1}^{30} {σ}^{t}} - {x}_{i , 0} )}^{2} ;$$
finding σ∈(0,1] to minimize Obj(σ) as an optimal decay factor σ; and
determining the optimal decay factor σ by:
dividing a range of σ into 1,000 parts for an x-axis of a graph;
obtaining a value of Obj(σ) at each part of the 1,000 parts, the Obj(σ) comprising a y-axis of the graph;
plotting Obj(σ) as a curve on the graph having a convex shape relative to the x-axis; and
selecting as the optimal decay factor σ a part of the 1,000 parts which archives a smallest Obj(σ) value on the curve.
